(19) United States
(12) Patent Application Publication
(10) Pub. No.: US 2006/0042209 A1
(43) Pub. Date: Mar. 2, 2006

(54) Alkaline impregnated filter element, and methods

(76) Inventors: Andrew James Dallas, Apple Valley, MN (US); Lefei Ding, St. Paul, MN (US); Jon Dennis Joriman, Little Canada, MN (US)

Correspondence Address: Merchant & Gould P.C., P.O. Box 2903, Minneapolis, MN, 55402-0903, US

(21) Appl. No.: 10/927,708

(22) Filed: Aug. 27, 2004

(51) Int. Cl. B01D 39/14

(52) U.S. Cl. 55/524

(57) ABSTRACT

A contaminant-removal filter for removing acidic contaminants from a gas stream, such as air. The filter has a porous or fibrous body that includes a plurality of passages extending from a first, inlet face to a second, outlet face, the passages providing flow paths. The body has a base or alkaline material, such as potassium carbonate, and a promoter, such as potassium iodide, impregnated throughout the substrate. The filter is free of any humectants.

### FIELD

The present invention relates to a low pressure-drop filter element for removing contaminants from a gas stream, such as an air stream. More particularly, the invention relates to removal of acidic contaminants from a gas stream, by using a filter element impregnated with basic or alkaline material.

### BACKGROUND

Gas adsorption articles, often referred to as elements or filters, are used in many industries to remove airborne contaminants to protect people, the environment, and often, a critical manufacturing process or the products that are manufactured by the process. A specific example of an application for gas adsorption articles is the semiconductor industry where products are manufactured in an ultra-clean environment, commonly known in the industry as a “clean room”. Gas adsorption articles are also used in many non-industrial applications. For example, gas adsorption articles are often present in air movement systems in both commercial and residential buildings, for providing the inhabitants with cleaner breathing air.

Typical airborne contaminants include basic contaminants, such as ammonia, organic amines, and N-methyl-2-pyrrolidone, acidic contaminants, such as hydrogen sulfide, hydrogen chloride, or sulfur dioxide, oxides of nitrogen, and general organic material contaminants, often referred to as VOCs (volatile organic compounds) such as reactive monomer or unreactive solvent. Silicon containing materials, such as silanes, siloxanes, silanols, and silazanes can be particularly detrimental contaminants for some applications. Additionally, many toxic industrial chemicals and chemical warfare agents must be removed from breathing air.

The dirty or contaminated air is often drawn through a granular adsorption bed assembly or a packed bed assembly. Such beds have a frame and an adsorption medium, such as activated carbon, retained within the frame. The adsorption medium adsorbs or chemically reacts with the gaseous contaminants from the airflow and allows clean air to be returned to the environment. The removal efficiency and the length of time at a specific removal efficiency are critical in order to adequately protect the processes and the products for extended periods.

The removal efficiency and capacity of the gaseous adsorption bed is dependent upon a number of factors, such as the air velocity through the adsorption bed, the depth of the bed, the type and amount of the adsorption medium being used, and the activity level and rate of adsorption of the adsorption medium. It is also important that for the efficiency to be increased or maximized, any air leaking through voids between the tightly packed adsorption bed granules and the frame should be reduced to the point of being eliminated. Examples of granular adsorption beds include those taught in U.S. Pat. No. 5,290,245 (Osendorf et al.), U.S. Pat. No. 5,964,927 (Graham et al.) and U.S. Pat. No. 6,113,674 (Graham et al.). These tightly packed beds result in a torturous path for air flowing through the bed.

However, as a result of the tightly packed beds, a significant pressure loss is incurred. Current solutions for minimizing pressure loss include decreasing air velocity through the bed by increased bed area. This can be done by an increase in bed size, forming the beds into V's, or pleating. Unfortunately, these methods do not adequately address the pressure loss issue, however, and can create an additional problem of non-uniform flow velocities exiting the bed.

Although the above identified packed bed contaminant removal systems are sufficient in some applications, what is needed is an alternate product that can effectively remove contaminants such as acids, bases, or other organic materials, while minimizing pressure loss and providing uniform flow velocities exiting the filter.

One example of a non-packed bed adsorbent article is disclosed in U.S. Pat. No. 6,645,271 (Seguin et al.). The articles described in this patent have a substrate having passages therethrough, the surfaces of the passages coated or covered with an adsorbent material. The adsorbent material can be held onto the substrate by a polymeric material.

U.S. Pat. No. 6,071,479 (Marra et al.) has attempted to provide a suitable article for removal of contaminants from a gas stream, however, various disadvantages and undesirable features are inherent in the article of Marra et al. For example, the media is not designed for long-term and/or high purity filtration applications. In accordance with the invention of Marra et al., paper media impregnated with base, and a humectant and/or urea is supposedly a suitable contaminant removal article; however, when in actual use, such a product does not provide acceptable performance. Marra et al. include a humectant or an organic amine in order to increase the water content of the adsorptive material, supposedly to aid in the reaction between the basic impregnant and acidic materials to be removed. Additionally, Marra et al. uses binders and glues to retain the structure of the formed media. Such adhesive materials are known to off-gas contaminants, some of which react with or bind with the contaminant-removal material, thus decreasing the amount available for removing contaminants from the gas flowing therethrough.

Better contaminant removal systems are needed.

### SUMMARY OF THE INVENTION

The present invention is directed to a contaminant-removal filter having a basic or alkaline material and a promoter. Applicants have found that prior to the present invention, basic materials in a filter element generally did not have an acceptable contaminant-removal life; the life of prior art filters is shortened by the presence of moisture within the filter. Applicants found that inclusion of a promoter with the basic material increases the useful life of the filter. Although not being bound by theory, Applicants believe that the promoter enhances the oxidation reaction between an acid gas (the contaminant being removed) and the basic or alkaline material of the filter, thus extending the use life of the filter.

The substrate forming the filter is a fibrous or porous material, such as cellulosic or polymeric material, or a combination thereof. The body of the filter, formed by the substrate, is preferably configured with a plurality of passages extending from an inlet face to an outlet face, the passages providing a pathway for gas flow therethrough.

Present at least on the surface of the substrate, and preferably within the substrate, is basic or alkaline material. A preferred basic material is potassium carbonate (K₂CO₃). The basic material reacts with or otherwise removes acidic contaminants from air or other gaseous fluid that contacts the filter. Also present on at least the surface, and preferably within the substrate, is a promoter. Generally, this promoter is homogeneously present with the basic material. A preferred promoter is potassium iodide (KI).

The contaminant-removal filter of the present invention can be used in a variety of high purity applications that desire the removal of acidic contaminants from a gas stream, such as an air stream. By use of the term “high purity” and modifications thereof, what is meant is a contaminant level, in the cleansed gas stream, of less than 1 ppm of contaminant. In many applications, the level desired is less than 1 ppb of contaminant. The contaminant-removal filter of the present invention is a “high purity element” or includes “high purity media”. In this application, such terms refer to materials that not only remove contaminants from the air stream but also do not diffuse or release any contaminants. Examples of materials that are generally not present in high purity elements or high purity media include adhesives or other polymeric materials that off-gas.

Generally, the filter can be used in any application such as lithographic processes, semiconductor processing, and photographic and thermal ablative imaging processes. Proper and efficient operation of a fuel cell also desires oxidant (e.g., air) that is free of unacceptable chemical contaminants. The filter can also be used in engine or power generating equipment that uses an air intake source for the combustion process. Other applications where the contaminant-removal filter of the invention can be used include those where environmental air is cleansed for the benefit of those breathing the air. Often, these areas are enclosed spaces, such as residential, industrial or commercial spaces, airplane cabins, and automobile cabins.

In one particular aspect, the invention is to a contaminant-removal filter element comprising a fibrous substrate, and a basic material and a promoter present throughout the substrate. The ratio of the promoter to the basic material can be 1:1 to 1:5000. In a preferred embodiment, the ratio of potassium iodide to potassium carbonate can be 1:1 to 1:4. Preferably, the filter element is free of any humectants.

In another particular aspect, the invention is to a contaminant-removal filter element comprising a fibrous substrate having a first face defining an inlet, a second face defining an outlet, and a plurality of passages extending from the first face to the second face. Basic material and a promoter are throughout the substrate.

In yet another aspect, the invention is directed to a method of making a contaminant-removal filter, the method comprising applying a mixture or solution of basic material and promoter to a substrate. The mixture can be a solution, with the basic material being, for example, potassium carbonate, and the promoter being, for example, potassium iodide. Typically, the mixture or solution is applied by impregnation.

### BRIEF DESCRIPTION OF THE DRAWINGS

Referring now to the drawings, wherein like reference numerals and letters indicate corresponding structure throughout the several views:

FIG. 1 is a schematic, perspective view of one embodiment of a contaminant-removal filter according to the present invention;

FIG. 2 is a schematic, perspective view of a second embodiment of a contaminant-removal filter according to the present invention;

FIG. 3 is a schematic, perspective view of a third embodiment of a contaminant-removal filter according to the present invention;

FIG. 4 is a schematic, perspective view of a fourth embodiment of a contaminant-removal filter according to the present invention;

FIG. 5 is a schematic depiction of a system incorporating multiple contaminant-removal filters according to the present invention, in conjunction with a particulate filter;

FIG. 6 is a schematic, perspective view of a fifth embodiment of a contaminant-removal filter according to the present invention;

FIG. 7 is a graphical representation of test results for various contaminant-removal filters according to the present invention;

FIG. 8 is a photograph of the inlet side of a filter element according to the present invention, after testing with Breakthrough Test 2; and

FIG. 9 is a photograph of the inlet side of a comparative example filter element, after testing with Breakthrough Test 2.

### DETAILED DESCRIPTION

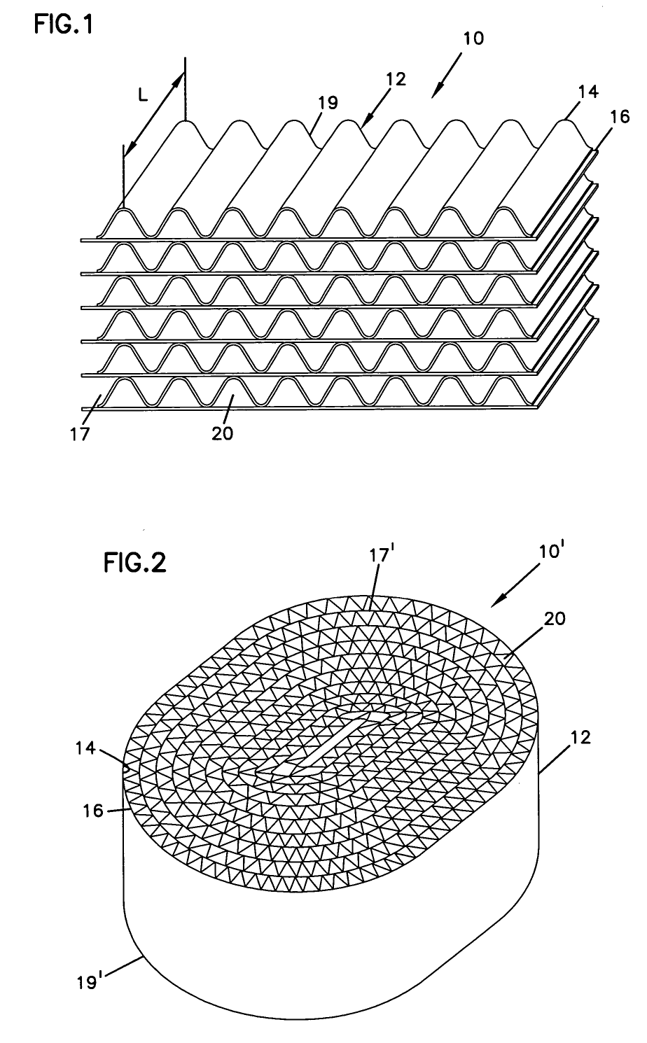

Referring now to the Figures, specifically to FIG. 1, a first embodiment of a contaminant-removal filter or element according to the present invention is shown at 10. Contaminant-removal filter 10 is defined by a body 12 having a first face 17 and an opposite second face 19. Generally, gas to be cleansed of basic contaminants enters filter 10 via first face 17 and exits via second face 19. In this embodiment, body 12 is formed by alternating a corrugated layer 14 with a facing layer 16. Corrugated sheet 14 has a rounded wave formation, with each of the valleys and peaks being generally the same. Facing layer 16 can be a corrugated layer or a non-corrugated (e.g., flat) sheet; in this embodiment facing layer 16 is a flat sheet. Layer 14 and layer 16 together define a plurality of passages 20 through body 12 that extend from first face 17 to second face 19. Filter 10 has “straight-through flow” or “in-line flow”, meaning that gas to be filtered enters in one direction through first face 17 and exits in generally the same direction from second face 19. The length of passages 20, “L”, is measured between first face 17 and second face 19; this dimension L generally also defines the thickness of body 12 and of filter 10, in the direction of airflow.

A second embodiment of a contaminant-removal filter according to the present invention is shown at 10′ in FIG. 2. Similar to the article of FIG. 1, contaminant-removal filter 10 is defined by a body 12′ having a first face 17′ and an opposite second face 19′. The distance between first face 17′ and second face 19′ is the thickness of filter 10′. Body 12′ is formed by alternating a corrugated layer 14′ with a facing layer 16′. Corrugated sheet 14′ has an angular wave formation, with each of the valleys and peaks being generally the same height. Facing layer 16′ can be a corrugated layer or a non-corrugated (e.g., flat) sheet; in this embodiment facing layer 16′ is a flat sheet. Layer 14′ and layer 16′ together define a plurality of passages 20′ through body 12′ that extend from first face 17′ to second face 19′.

Body 12 of FIG. 1 and body 12′ of FIG. 2 have a similar construction in that they both include a corrugated layer 14, 14′ and a facing layer 16, 16′. For body 12, two layers 14, 16 are alternatingly stacked, providing a generally planar filter 10. For body 12′, two layers 14′, 16′ are alternatingly coiled, providing a generally cylindrical filter 10′. Filter 10′ illustrated has a non-circular cross-section, such as an oval, elliptical, or racetrack shape; other shapes, particularly a circle, could also be formed by coiling layers 14′, 16′. Additionally, a shape having two parallel sides, two other parallel sides orthogonal to the first two parallel sides, and four rounded corners therebetween, could also be coiled. Any coiled construction could include a central core to facilitate winding of the layers.

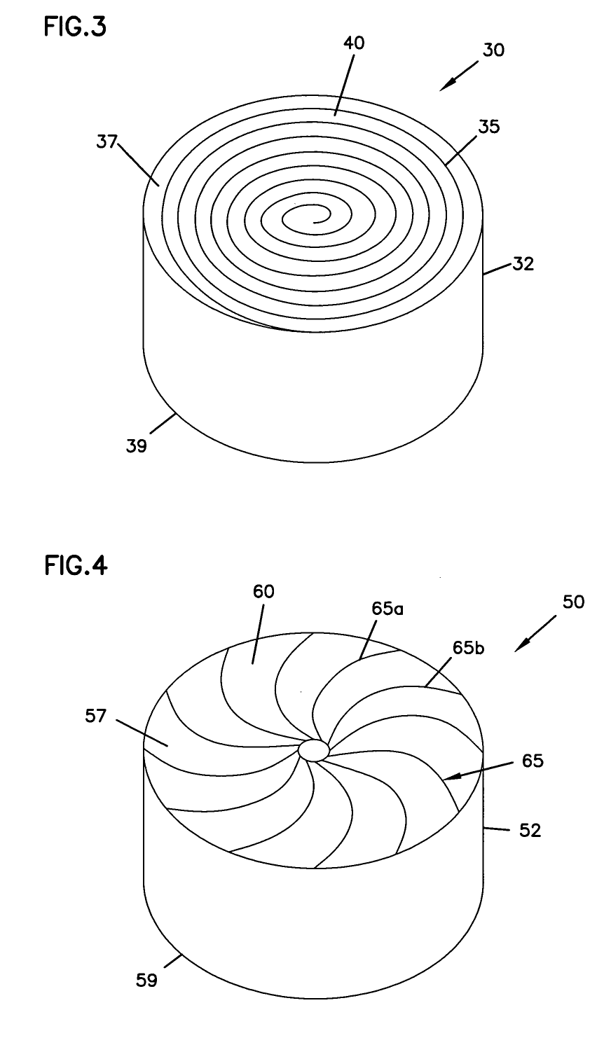

A third embodiment of a contaminant-removal filter according to the present invention is shown at 30 in FIG. 3. Contaminant-removal filter 30 is defined by a body 32 having a first face 37 and an opposite second face 39. Generally, gas to be cleansed enters filter 30 via first face 37 and exits via second face 39. The distance between first face 37 and second face 39 is the thickness of filter 30. Body 32 is formed by spiral winding a substrate layer 35. Spacers may be used to obtain the desired spacing between adjacent wraps of layer 35. The adjacent wraps of layer 35 form a passage through filter 30. Similar to filter 10′ of FIG. 2, filter 30 can have a circular or non-circular cross-section, and can include a central core to facilitate winding of the layers.

A fourth embodiment of a contaminant-removal filter according to the present invention is shown at 50 in FIG. 4. As with the previous embodiments, filter 50 is defined by a body 52 having a first face 57 and an opposite second face 59. The distance between first face 57 and second face 59 is the thickness of filter 50. Body 52 is formed by multiple individual sheets 65 of substrate arranged to form a generally spiraling configuration. For example, body 52 has a first sheet 65a, an adjacent second sheet 65b, and subsequent sheets. These sheets 65, although generally flat, may be corrugated. Adjacent sheets 65, such as 65a and 65b, together define a plurality of passages 60 through body 52 that extend from first face 57 to second face 59. As with the previous embodiments, element 50 can have a circular or non-circular cross-section and can include a core to facilitate placement of sheets 65.

Another anticipated configuration for a contaminant-removal filter according to the present invention is to have concentric layers, formed by multiple, individual sheets.

Specific features of the contaminant-removal filters are described below. For ease, although generally only the reference numerals from the first embodiment, filter 10, are used, it is understood that the description of the features applies to all embodiments, unless specifically indicated.

Body of the Filter

Body 12 provides the overall structure of contaminant-removal filter 10; body 12 defines the shape and size of filter 10. Body 12 can have any three-dimensional shape, such as a cube, cylinder, cone, truncated cone, pyramid, truncated pyramid, disk, etc., however, it is preferred that first face 17 and second face 19 have at least close to the same surface area, to allow for equal flow into passages 20 as out from passages 20. The cross-sectional shape of body 12, defined by first face 17, second face 19, or any cross-section taken between faces 17 and 19, can be any two dimensional shape, such as a square, rectangle, triangle, circle, star, oval, ellipse, racetrack, and the like. An annular shape can also be used. Preferably, the cross-section of body 12 is essentially constant along length “L” from first face 17 to second face 19.

Typically, first face 17 and second face 19 have the same area, which is at least 1 cm². Additionally or alternatively, first face 17 and second face 19 have an area that is no greater than about 1 m². In most embodiments, the area of faces 17, 19 is about 70 to 7500 cm. Specific applications for filter 10 will have preferred ranges for the area. The thickness “L” of body 12, between first face 17 and second face 19, is generally at least 0.5 cm, and generally no greater than 25 cm. In most embodiments, “L” is about 2 to 10 cm. Two particular suitable thicknesses of body 12 are 2.5 cm and 7.5 cm. The dimensions of body 12 will effect the residence time of gas in the filter and the resulting removal of contaminant from the gas stream.

Body 12 typically has a plurality of passages 20 extending therethrough; see, for example, elements 10 and 10′ of FIGS. 1 and 2. Passages 20 may have any shape, for example square, rectangular, triangular, circular, trapezoidal, hexagonal (e.g., “honeycomb”), but a preferred shape is generally domed, such as those illustrated in FIG. 1. Preferably, the shape of passages 20 does not appreciably change from first face 17 to second face 19, and each of passages 20 within filter 10 has a similar cross-sectional shape.

Each passage 20 generally has a cross-sectional area typically no greater than about 50 mm²; this cross-sectional area is generally parallel to at least one of first face 17 and second face 19. Alternately or additionally, passages 20 typically have a cross-sectional area no less than about 1 mm². Generally the cross-sectional area of each passage 20 is about 1.5 to 30 mm², often about 2 to 4 mm². In one preferred embodiment, the cross-sectional area of a domed passage 20, such as passage 20 illustrated in FIG. 1, is about 7 to 8 mm². In another preferred embodiment, the area of passage 20 is 1.9 mm².

The longest cross-sectional dimension of passages 20 is typically no greater than 10 mm, often no greater than 6 mm. Additionally, the shortest dimension of passages 20 is no less than 0.25 mm, often no less than 1.5 mm.

The total, internal surface area of each elongate passage 20 is generally no less than about 5 mm², and is generally no greater than about 200 cm². The total surface area of filter 10, as defined by the interior surface area of passages 20, is at least about 200 cm² or about 250 cm² to 10 m².

In the third embodiment, FIG. 3, element 30 has a single passage, formed by the subsequent and adjacent winds of layer 35. In such an embodiment, the total internal surface area of element 30 is at least about 200 cm² and is usually about 250 cm² to 10 m².

The passage walls, which define the shape and size of passages 20, are defined by the substrate that forms body 12. The substrate is generally at least 0.015 mm thick. Alternately or additionally, the passage walls are generally no thicker than 5 mm. Typically, the passage walls are no greater than 2 mm thick. The thickness of the walls will vary depending on the size of passage 20, the substrate from which body 12 is made, and the intended use of filter 10. For those embodiments where layer 14 and facing layer 16 define passages 20, the passage walls are defined by layer 14 and facing layer 16.

In most embodiments, each of passages 20 has a continuous size and shape along its length. Generally, the length of each passage 20 is essentially the same as the thickness “L” between first face 17 and second face 19. It is contemplated that passage 20 is not a straight line from face 17 to face 19, however, this is generally not preferred, due to the potential of undesirable levels of pressure drop through passage 20.

Body 12 (e.g., layers 14, 16) is formed from a porous or permeable substrate; a fibrous material is a preferred material. Examples of suitable substrates for body 12 include natural (e.g., cellulosic materials) and polymeric based materials. The substrates can be nonwoven fibrous materials (such as spun-bonded), woven fibrous materials, knitted fibrous materials, or open or closed cell foam or sponge materials. Specific examples of suitable substrates include glass fiber papers, crepe papers, Kraft papers, wool, silk, cellulosic fiber fabrics (such as cotton, linen, viscose or rayon) and synthetic fiber fabrics (such as nylon, polyester, polyethylene, polypropylene, polyvinylalcohol, acrylics, polyamide and carbon fiber). Porous ceramic materials may also be used for body 12.

The materials used should not produce deleterious off-gassing or emissions of contaminants that might affect the functioning of the acidic material present on body 12. Examples of materials that are preferably avoided include adhesives and other such materials that off-gas.

An example of a preferred substrate for body 12 has thermoplastic polymeric fibers combined with cellulose fibers. The two fibers can be homogeneously combined and formed into a sheet-like substrate. Upon heating, the polymeric fibers at least partially melt, binding the fibers together. Upon cooling, the polymeric fibers resolidify. Using such a substrate allows joining multiple sheets or layers of substrate without using an adhesive. A specific example of a substrate has about 40 wt-% polyethylene terephthalate (PET) fibers and about 60 wt-% cellulose fibers. Other combinations of thermoplastic and non-thermoplastic fibers would also be suitable.

An example of a preferred body 12, such as illustrated in FIG. 2, can be made from a corrugated sheet 14 and a facing sheet 16, both made from thermoplastic polymeric fibers combined with cellulose fibers. The sheets 14, 16 can be passed through an ultrasonic welder, which uses high frequency sound to locally heat the sheets. Pressure is applied at the areas where sheets 14, 16 contact each other, thus bonding sheets 14, 16 together.

Methods for making body 12, from a corrugated sheet 14 and a facing sheet 16 are taught, for example, are taught in U.S. Pat. No. 6,416,605 and in WO 03/47722, which are incorporated herein by reference. Body 12 is a carrier for the acidic material that removes contaminants from air or other gaseous fluid passing through filter 10.

Basic Material

Each contaminant-removal filter 10 includes basic material. The basic material removes acidic contaminants from the air passing through the passages by reacting with or otherwise removing the contaminants. The basic material is preferably present throughout body 12; typically, the basic material is impregnated, from liquid, into the substrate that forms body 12.

Examples of suitable basic materials for use in the element of the invention include basic salts such as carbonates, bicarbonates, hydroxides, quaternary ammonium compounds (generally the hydroxide forms); and metal oxides such as copper oxides, manganese oxides, and iron oxides. Ion—exchange resins, such as those that include polystyrene quaternary ammonium (hydroxide forms), polystyrene tertiary amine, grafted polyethylene, and grafted polypropylene, are also suitable for removal of basic-contaminants. For basic salts of alkali and alkaline earth metals; typically the lithium, sodium, and potassium versions are used. Potassium carbonate is the preferred basic material for use in contaminant-removal element 10. Examples of other preferred basic materials include potassium bicarbonate, sodium carbonate, and sodium bicarbonate.

To produce filter 10, the basic material is provided in a liquid carrier and is impregnated into or onto the substrate that forms the contaminant-removal filter. Typically and preferably, the basic material is impregnated into the substrate while in the form of a basic solution. It is understood that some materials may not dissolve in the solvent, but rather, are dispersed. Water is the preferred solvent for the solution, dispersion, or any other mixture form in which the basic material may be.

The level of basic material within the impregnant solution is selected based on the basic material and the substrate being used. The amount of basic material in the solution is at least about 0.5 wt-% and is no more than about 75 wt-%. Preferably, the amount of basic material is 10-50 wt-%. For the preferred basic material, potassium carbonate, the amount is about 10-50 wt-%, preferably 15-35 wt-%. Other levels of basic material would also be suitable.

Although the terms “impregnation”, “impregnate”, “impregnant”, and the like have been used, it should be understood that the method of application of the basic material to the substrate is not limited to impregnation. Other methods may be used to provide the basic material into the substrate. Other alternate and suitable methods for applying the basic material into the substrate include immersion, spraying, brushing, knife coating, kiss coating, and other methods that are known for applying a liquid onto a surface or substrate. The impregnation or other application method can be done at atmospheric conditions, or under pressure or vacuum.

In a preferred method, the substrate is formed into body 12 prior to application of the basic material. It is understood, however, that body 12 could be formed after the substrate has been formed into body 12.

After being impregnated, the substrate is at least partially dried to remove solvent (e.g., water), leaving basic material in and on the substrate. Preferably, at least 90% all free water or other solvent is removed, and most preferably, at least 95% of all free water or other solvent is removed.

The basic material is present on and within at least 50% of the surface area of the passages 20 of the element. Preferably, the basic material is present on and within at least 55 to 75% of the passage wall surfaces, more preferably at least 90% of the surfaces, and most preferably, is continuous and contiguous with no areas without the basic material. The basic material is present through at least 10% of the thickness of the substrate. Preferably, the basic material is present through at least 50% of the substrate, and more preferably through at least 80%.

The basic material generally does not generally increase the thickness of the substrate. The basic material, may however, alter the characteristics of the substrate, such as making it more rigid, or more flexible.

Additives to be Avoided

It is theorized that increased levels of moisture in the substrate decrease the suitable life of the element. Thus the use of humectants, which increase the amount of water content in the dried substrate, is undesired. Examples of humectants to be avoided include urea, glycerol, glycerin, alcohols, polyvinylpyridine, polyvinylpyrrolidone, polyvinylalcohols, polyacrylates, polyethylene glycols, and cellulosic acetates. Also, the use of organic amines, which increase the amount of water content in the dried substrate, is undesired. Examples of organic amines to be avoided include alkanol amines, hydroxylamines, and polyamines.

Additives

Applicants have found that adding a promoter to the basic or alkaline material improves the effectiveness of the basic or alkaline material over the life of the element and extends the life of the filter element.

The level of promoter within the impregnant solution is selected based on the basic material and the promoter being used. Examples of suitable promoters are alkali and alkaline earth metal iodides and iodates, such as potassium iodide, sodium iodide, lithium iodide, potassium iodate, sodium iodate, and sodium iodate. A preferred promoter is potassium iodide; this promoter is particularly suitable for use with potassium carbonate material.

The amount of promoter in the solution is at least about 0.01 wt-% and is no more than about 20 wt-%. Preferably, the amount of promoter is 0.1-10 wt-%, and more preferably about 0.1-5 wt-%. These levels are particularly suitable when the basic material is about 5 wt-%. Other levels of promoter would also be suitable. The preferred level of promoter, as a ratio to the basic material, is about 1:1 to 1:50, more preferably about 1:3 to 1:10.

It has been found the contaminant-removal filter of this invention can be regenerated. After use, or after a prolonged duration of non-use, the element can be again impregnated with basic material. This second or any subsequent impregnation can be done with or without cleansing the previous contaminants from the filter; cleansing the filter could be done, for example, by a water rinse. It is foreseen that the substrate can be impregnated any number of times, any limitation being the physical intactness of the substrate.

Applications for Contaminant-Removal Filter 10

Contaminant-removal filter 10 of the present invention can be used in any variety of applications that desire the removal of acidic contaminants from a gas stream, such as an air stream. Examples of common airborne acidic contaminant compounds include oxides of sulfur, oxides of nitrogen, HCl (hydrochloric acid), HNO₃ (nitric acid), H₂S (hydrogen sulfide), H₂SO₄ (sulfuric acid) and HCN (hydrogen cyanide).

Contaminant-removal filter 10 is particularly suitable for high purity applications that desire the removal of chemical contaminants from a gas to a level of less than 1 ppm of contaminant. In many high purity applications, the level desired is less than 1 ppb of contaminant. Filter 10 itself generally adds no contaminants, such as due to off-gassing.

Generally, contaminant-removal filter 10 can be used in any application where a packed granular bed has been used; such applications include lithographic processes, semiconductor processing, photographic and thermal ablative imaging processes. Proper and efficient operation of a fuel cell would benefit from intake air that is free of unacceptable basic contaminants. Other applications where contaminant-removal filter 10 can be used include those where environmental air is cleansed for the benefit of those breathing the air. Filter 10 can be used with personal devices such as respirators (both conventional and powered) and with self-contained breathing apparatus to provide clean breathing air. Contaminant-removal filter 10 can also be used on a larger scale, for enclosed spaces such as residential and commercial spaces (such as rooms and entire buildings), airplane cabins, and automobile cabins. Filter 10 can also be used to protect engine or power generating equipment that use an air intake source for the combustion process. At other times, it is desired to remove contaminants prior to discharging the air into the atmosphere; examples of such applications include automobile or other vehicle emissions, exhaust from industrial operations, gas turbines or any other operation or application where chemical contaminants can escape into the environment.

Filter 10 is typically positioned in a housing, frame or other type of structure that directs gas flow (e.g., air flow) into and through passages 20 of filter 10. In many configurations, filter 10 is at least partially surrounded around its perimeter by a housing, frame or other structure.

When a contaminant-removal filter 10, made by any process described herein, is positioned within a system, a pre-filter, a post-filter, or both may be used in conjunction with contaminant-removal filter 10. A pre-filter is positioned upstream of filter 10 to remove airborne particles prior to engaging filter 10. A post-filter is positioned downstream of filter 10 to remove residual particles from filter 10 before the air is released. These filters are generally placed against or in close proximity to first face 17 and second face 19, respectively, of contaminant-removal filter 10. An example of a system including a pre-filter is illustrated in FIG. 5.

In FIG. 5, a system 100 is illustrated for removing contaminants from a dirty gas stream 101. System 100 includes a particulate filter 105, a first contaminant-removal filter 110, and a second contaminant-removal filter 110′. Particulate filter 105 is configured to remove solid particles, such as dust and smoke, from gas stream 101. Typically, if particulate filter 105 is used, particulate filter 105 is positioned upstream of contaminant-removal filters 110 and 110′, to decrease the potential of filters 110, 110′ being clogged or laden with particulate. First contaminant-removal filter 110 is configured to remove acidic contaminants from gas stream 101. Second contaminant-removal filter 110′ may be configured to remove, for example, basic contaminants from gas stream 101; examples of suitable contaminant-removal filters 110′ to remove basic contaminants are described in U.S. patent application having Ser. No. 10/______, filed on even date herewith (attorney docket 758.1605US01). It is understood that in alternate embodiments, filters 110, 110′ can be configured to remove basic contaminants and then acidic contaminants. After passing through each of particulate filter 105, contaminant-removal filter 110, and contaminant-removal filter 110′, the resulting cleaned gas stream is designated as 102.

Any or all of particulate filter 105, filter 110, and filter 110′ may be retained in a housing, such as housing 120. Filters 105,110, 110′ may be positioned adjacent one another, or may have spacing therebetween.

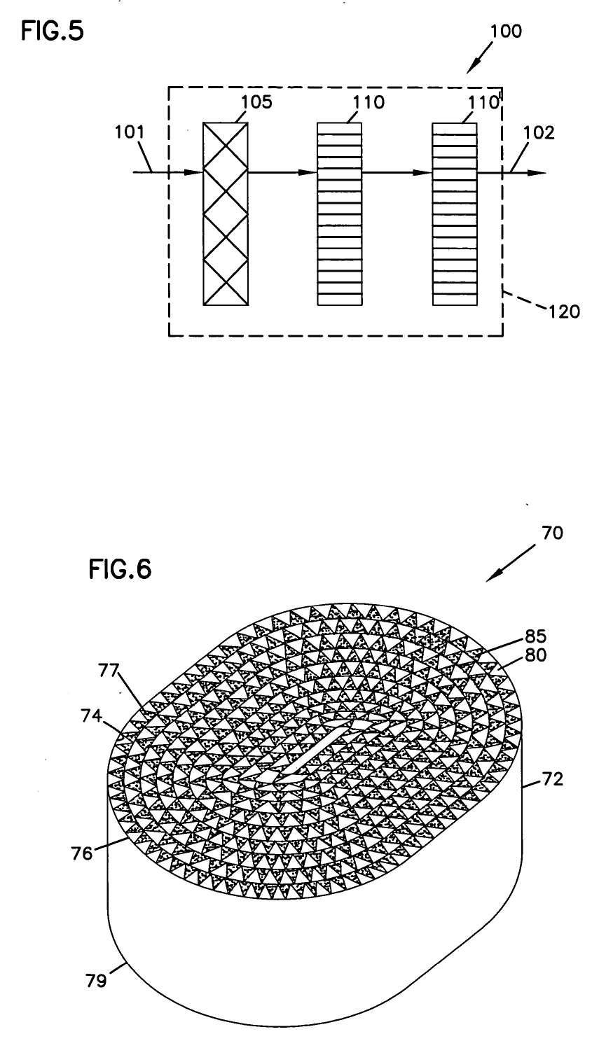

An alternate configuration for a combined acid-contaminant-removal filter and particulate filter is illustrated in FIG. 6 as filter 70. Contaminant-removal filter 70 is defined by a body 72 having a first face 77 and an opposite second face 79. Generally, gas to be cleansed of acidic contaminants enters filter 70 via first face 77 and exits via second face 79. Body 72 is similar to body 12 of filter 10′ of FIG. 2, having alternating corrugated layer 74 and facing layer 76. Layer 74 and layer 76 together define a plurality of passages 80. A first set of passages 80 are blocked or sealed at first face 79; these are illustrated as seals 85. At the opposite end of seals 85, at second face 79, passages 80 are open. Additionally, a second set of passages 80 are blocked or sealed at the second face 79 and are open at the first face 79.

In use, particulate laden gas enters open passage 80 at first face 79. The particulates become trapped in passages 80 due to the sealed second face 79, whereas the gas passes through the passage walls, formed by the fibrous substrate. The basic material in and on the substrate removes any acidic contaminants. The cleaned gas exits via second face 79.

Filter 70 is referred to a z-filter, a straight-through flow filter, or an in-line filter. The particulate removal features of such a filter as filter 70 are disclosed, for example, in U.S. Pat. Nos. 5,820,646; 6,190,432; 6,350,291.

Positioned downstream of filter 10 or any of the other embodiments can be an indicator or indicating system to monitor the amount, if any, of contaminant that is passing through filter 10 without being removed. Such indicators are well known.

The shape and size of filter 10 is to remove the desired amount of contaminants from the gas or air passing therethrough, based on the residence time of the gas in filter 10. For example, preferably at least 90%, more preferably at least 95% of acidic contaminants are removed. In some designs, as much as 98%, or more, of the contaminant is removed. It is understood that the desired amount on contaminants to be removed will differ depending on the application and the amount and type of contaminant. As an example, for a semiconductor processing facility, the residence time of the incoming air in filter 10 is usually about 0.06 to 0.36 seconds, which can be accomplished with an element having a thickness of about 7.6 to 15 cm.

### EXAMPLES

The following non-limiting examples will further illustrate the invention. All parts, percentages, ratios, etc., in the examples are by weight unless otherwise indicated.

The following substrate body was used for the example contaminant-removal elements:

Body 1: Body 1 was similar to that of FIG. 2, formed by alternating a flat facing sheet and a sinusoidal corrugated sheet. The sheets were made from 60% cellulose fibers and 40% PET fibers. The sheets were wrapped to form a cylinder. The resulting domed passages had an approximate height of 1.05 mm and width of 2.90 mm. The cross-sectional area of each passage was about 1.5 mm². The sheets were held together by the thermoplastic material from the sheets, which had been melted with heat created by ultrasonic energy, and then had cooled.

The bodies were impregnated with basic material by the following method. A volume of basic solution was placed in a beaker. The fibrous body was placed into the beaker, so that entire body was immersed in the solution. After approximately 60 seconds, the body was removed and allowed to dry in an oven for 1 hour.

After drying, the resulting filter element was tested to determine its estimated life. The filter element was placed in a test chamber and sealed to provide an upstream side of the filter and a downstream side.

Breakthrough Test 1

For Breakthrough Test 1, an air stream that contained 500 ppb SO₂ and 50% relative humidity was delivered to the upstream side of the filter element at a flow rate of 30 liters/minute. The upstream and downstream sulfur dioxide concentrations were monitored using an SO₂ detector.

Breakthrough Test 2

For Breakthrough Test 2, an air stream that contained 50 ppm SO₂ and 50% relative humidity was delivered to the upstream side of the filter element at a flow rate of 30 liters/minute. The upstream and downstream sulfur dioxide concentrations were monitored using an SO₂ detector.

### Comparative Example A

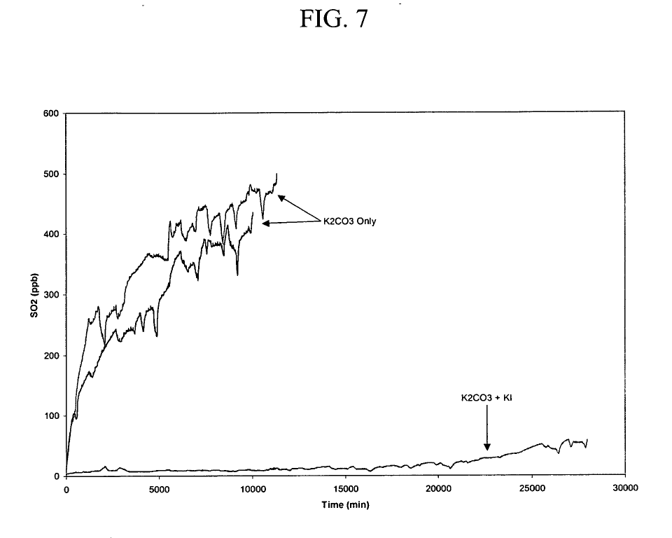

A solution of 20 wt-% potassium carbonate (K₂CO₃) in water was made. Body 1, having a diameter of about 3.8 cm and a length of about 7.5 cm, was impregnated with the solution. Comparative Example A was tested with Breakthrough Test 1, and the results are illustrated in the graph of FIG. 7.

### Comparative Example B

A solution of 20 wt-% K₂CO₃ in water was made. Body 1, having a diameter of about 3.8 cm and a length of about 7.5 cm, was impregnated with the solution. Comparative Example B was tested with Breakthrough Test 1, and the results are illustrated in the graph of FIG. 7.

### Example 1

A solution of 20 wt-% K₂CO₃ and 6.6 wt-% KI in water was made. Body 1, having a diameter of about 3.8 cm and a length of about 7.5 cm, was impregnated with the solution. Example 1 was tested with Breakthrough Test 1, and the results are illustrated in the graph of FIG. 7.

FIG. 7 shows the SO₂ levels passing through the tested filter elements over time.

It is seen that Example 1, which included a promoter, provides better SO₂ removal than the Comparative Examples.

### Comparative Example C

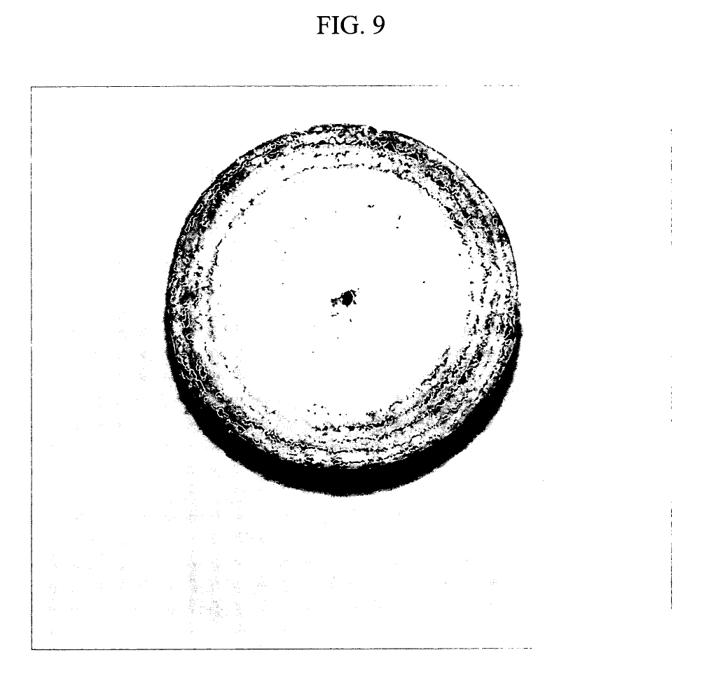

A solution of 20 wt-% K₂CO₃ in water was made. Body 1, having a diameter of about 3.8 cm and a length of about 7.5 cm, was impregnated with the solution. Comparative Example C was tested with Breakthrough Test 2. A photograph of the tested sample is illustrated in FIG. 9.

### Example 2

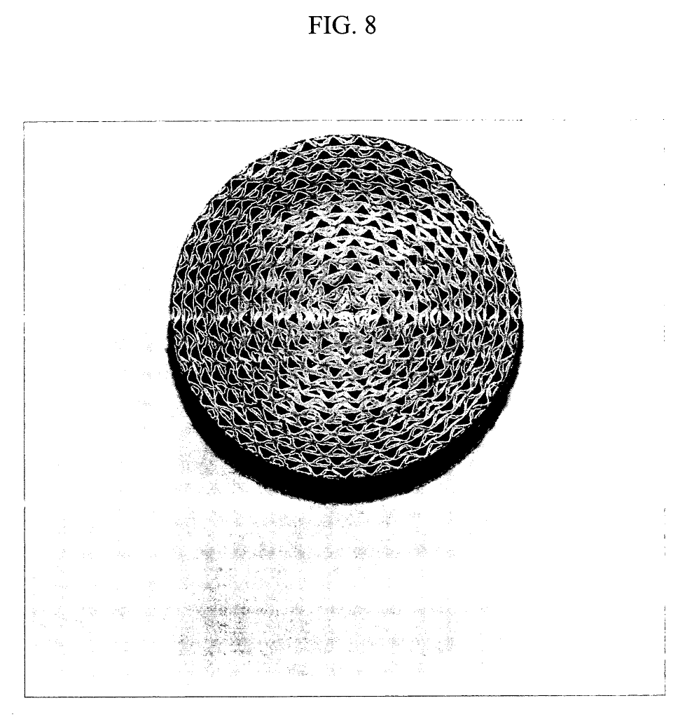

A solution of 20 wt-% K₂CO₃ and 6.6 wt-% KI in water was made. Body 1, having a diameter of about 3.8 cm and a length of about 7.5 cm, was impregnated with the solution. Example 2 was tested with Breakthrough Test 2. A photograph of the tested sample is illustrated in FIG. 8.

The quantitative test results for Comparative Example C and Example 2, from Breakthrough Test 2, showed that the filter element life of the two was similar. However, comparison of FIGS. 8 and 9 show that even though the two samples adsorbed the same amount of SO₂, there was a significant difference in the pressure drop across the filters. As seen in FIG. 9, the inlet face of Comparative Example C has significant build-up of material, thus reducing the available volume for air flow therethrough. The crystal build-up on the inlet side of Comparative Example C was identified as K₂SO₃. This build-up was not seen on Example 2, FIG. 8. This build-up was not seen with Breakthrough Test 1, under lower concentration.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed:

1. A contaminant-removal filter comprising:
a body comprising a fibrous substrate, and
basic material and a promoter throughout the substrate,
the filter being free of any humectants.

2. The filter according to claim 1, wherein the basic material is an alkali metal or alkaline earth metal selected from the group consisting of carbonates, bicarbonates, and hydroxides, a quaternary ammonium compound, a metal oxides, a basic anion ion-exchange resin, or combination thereof.

3. The filter according to claim 2, wherein the basic material is potassium carbonate.

4. The filter according to claim 1, wherein the promoter is potassium iodide, sodium iodide, lithium iodide, potassium iodate, sodium iodate, or lithium iodate.

5. The filter according to claim 4, wherein the promoter is potassium iodide.

6. The filter according to claim 1, wherein a ratio of the promoter to the basic material is 1:1 to 1:5000.

7. The filter according to claim 6, wherein the ratio of the promoter to the basic material is 1:1 to 1:10.

8. The filter according to claim 1, wherein the fibrous substrate has a first face and a second face, and a plurality of passages extending from the first face to the second face.

9. The filter according to claim 1, wherein the fibrous substrate comprises thermoplastic and cellulosic fibers.

10. A contaminant-removal filter comprising:
a body comprising a fibrous substrate, the body comprising a first face defining an inlet, a second face defining an outlet, and a plurality of passages extending from the first face to the second face; and
basic material and a promoter, present at a ratio of 1:1 to 5000:1, throughout the substrate.

11. The filter according to claim 10, wherein the basic material is an alkali metal or alkaline earth metal selected from the group consisting of carbonates, bicarbonates, and hydroxides, a quaternary ammonium compound, a metal oxides, a basic anion ion-exchange resin, or combination thereof.

12. The filter according to claim 11, wherein the basic material is potassium carbonate.

13. The filter according to claim 10, wherein the promoter is potassium iodide, sodium iodide, lithium iodide, potassium iodate, sodium iodate, or lithium iodate.

14. The filter according to claim 13, wherein the promoter is potassium iodide.

15. The filter according to claim 10, wherein the ratio of the basic material to the promoter is 3:1 to 10:1.

16. The filter according to claim 10 being free of any humectant.

17. A method of making a contaminant-removal filter, the method comprising:
(a) providing a substrate;
(b) applying a mixture comprising 5-50 wt-% basic material and 0.01-10 wt-% promoter to the substrate.

18. The method of claim 17, wherein the step of applying a mixture comprising basic material and promoter to the substrate comprises:
(a) applying a mixture comprising potassium carbonate and a promoter.

19. The method of claim 18, wherein the step of applying a mixture comprising potassium carbonate and a promoter comprises:
(a) applying a mixture comprising potassium carbonate and potassium iodide.

20. The method of claim 19, wherein the step of applying a mixture comprising potassium carbonate and potassium iodide comprises:
(a) applying a mixture comprising 5-50 wt-% potassium carbonate and 0.01-10 wt-% potassium iodide to the substrate.

21. The method of claim 15, wherein after the step of applying a mixture comprising 5-50 wt-% basic material and 0.01-10 wt-% promoter to the substrate, further comprising:
(a) applying a mixture comprising 5-50 wt-% basic material and 0.01-10 wt-% promoter to the substrate.
